(19) United States
(12) Patent Application Publication
(10) Pub. No.: US 2025/0037296 A1
(43) Pub. Date: Jan. 30, 2025

(54) PRIVACY PRESERVING VISUAL LOCALIZATION WITH SEGMENTATION BASED IMAGE REPRESENTATION

(71) Applicants: NAVER CORPORATION, Gyeonggi-do (KR); NAVER LABS CORPORATION, Gyeonggi-do (KR)

(72) Inventors: Maxime PIETRANTONI, Claye-Souilly (FR); Gabriela Csurka Khedari, Meylan (FR); Martin Humenberger, Gieres (FR); Torsten Sattler, Praha 13-Stodulky (CZ)

(73) Assignees: NAVER CORPORATION, Gyeonggi-do (KR); NAVER LABS CORPORATION, Gyeonggi-do (KR)

(21) Appl. No.: 18/541,808

(22) Filed: Dec. 15, 2023

Related U.S. Application Data
(60) Provisional application No. 63/528,739, filed on Jul. 25, 2023.

(51) Int. Cl. G06T 7/70; G06T 7/10; G06V 10/44; G06V 10/764; G06V 10/771; G06V 20/70

(52) U.S. Cl. CPC G06T 7/70; G06T 7/10; G06V 10/44; G06V 10/764; G06V 10/771; G06V 20/70; G06T 2207/20081

(57) ABSTRACT

A training system includes: a pose module configured to: receive an image captured using a camera; and determine a 6 degree of freedom (DoF) pose of the camera; and a training module configured to: input training images to the pose module from a training dataset; and train a segmentation module of the pose module by alternating between: updating a target distribution with parameters of the segmentation module fixed based on minimizing a first loss determined based on a label distribution determined based on prototype distributions determined by the pose module based on input of ones of the training images; updating the parameters of the segmentation module with the target distribution fixed based on minimizing a second loss determined based on a second loss that is different than the first loss; and updating the parameters of the segmentation module based on a ranking loss using a global representation.

### CROSS-REFERENCE TO RELATED APPLICATIONS

This application claims the benefit of U.S. Provisional Application No. 63/528,739, filed on Jul. 25, 2023. The entire disclosure of the application referenced above is incorporated herein by reference.

### FIELD

The present disclosure relates to systems and methods for determining camera pose and more particularly to systems and methods for determining camera pose while preserving privacy.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are mobile robots that may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants from a pickup to a destination.

### SUMMARY

In a feature, a training system includes: a pose module configured to: receive an image captured using a camera; and determine a 6 degree of freedom (DoF) pose of the camera that captured the image; and a training module configured to: input training images to the pose module from a training dataset; and train a segmentation module of the pose module by alternating between: updating a target distribution with parameters of the segmentation module fixed based on minimizing a first loss determined based on a label distribution determined based on prototype distributions determined by the pose module based on input of ones of the training images; updating the parameters of the segmentation module with the target distribution fixed based on minimizing a second loss determined based on a second loss that is different than the first loss; and updating the parameters of the segmentation module based on a ranking loss using a global representation.

In further features, the second loss is a per pixel cross-entropy loss.

In further features, the training module is configured to train the segmentation module based on: a first function based on feature vectors and prototype distributions during a first epoch of a predetermined number of epochs of the training; and a second function during the remainder of the predetermined number of epochs after the first epoch.

In further features, the training module is configured to train the pose module further based on minimizing a consistency loss.

In further features, the training module is configured to determine the consistency loss based on labels assigned to keypoints in the training images based on their distance to prototype distributions.

In further features, the training module is configured to determine the consistency loss based on feature maps determined based on the training images.

In further features, the training module is configured to train the segmentation module further based on minimizing a contrastive loss.

In further features, the training module is configured to determine the contrastive loss based on based on prototype distributions determined based on ones of the training images, feature maps determined based on the training images, and concentrations of the prototype distributions.

In further features, the ranking loss is a multi-similarity loss.

In further features, the segmentation module includes a plurality of transformer modules having the transformer architecture.

In further features, the pose module is configured to: determine segmentation heatmaps based on the image; determine a global descriptor based on the segmentation heatmaps; select k images from memory based on similarities between the global descriptor and global descriptors of the k images, respectively; determine an initial pose based on the k most similar images; and determine the 6 DoF pose of the camera that captured the image based on the initial pose.

In further features, the similarities are cosine similarities.

In further features, the pose module is configured to determine the prototype distributions based on centers of the input of the ones of the training images.

In a feature, a pose determination system includes: a segmentation module configured to determine segmentation heatmaps based on an image received from a camera; a retrieval module configured to select k images from memory based on similarities between a global descriptor for the image and global descriptors of the k images, respectively, the map being stored in memory and including labeled three dimensional 3D points; an initial pose module configured to determine an initial pose based on the k most similar images; and a refinement module configured to determine a 6 DoF pose of the camera that captured the image based on the initial pose and using the map.

In further features, a global representation module is configured to generate the global descriptor based on the image.

In further features, a pooling module is configured to generate the global descriptor using a pooling operator on the segmentation heatmaps.

In further features, the refinement module is configured to determine the 6 DoF pose further based on the segmentation heatmaps.

In further features, the labels of the three dimensional 3D points of the map correspond to segmentation classes.

In further features, the segmentation classes are semantic classes derived in a self-supervised manner using pixel correspondences.

In further features, the memory includes labeled three dimensional (3D) points includes for a set of reference images their corresponding camera pose and global descriptors but not their corresponding reference images.

In further features, each of the 3D points is associated to one of a predefined set of class labels.

In a feature, a training method includes: receiving an image captured using a camera; determining, by a pose module, a 6 degree of freedom (DoF) pose of the camera that captured the image; input training images to the pose module from a training dataset; and training a segmentation module of the pose module by alternating between: updating a target distribution with parameters of the segmentation module fixed based on minimizing a first loss determined based on a label distribution determined based on prototype distributions determined by the pose module based on input of ones of the training images; updating the parameters of the segmentation module with the target distribution fixed based on minimizing a second loss determined based on a second loss that is different than the first loss; and updating the parameters of the segmentation module based on a ranking loss using a global representation.

In further features, the second loss is a per pixel cross-entropy loss.

In further features, the training includes training the segmentation module based on a first function based on feature vectors and prototype distributions during a first epoch of a predetermined number of epochs of the training; and a second function during the remainder of the predetermined number of epochs after the first epoch.

In further features, the training includes training the pose module further based on minimizing a consistency loss.

In further features, the training includes determining the consistency loss based on labels assigned to keypoints in the training images based on their distance to prototype distributions.

In further features, the training includes determining the consistency loss based on feature maps determined based on the training images.

In further features, the training includes training the segmentation module further based on minimizing a contrastive loss.

In further features, the training incudes determining the contrastive loss based on based on prototype distributions determined based on ones of the training images, feature maps determined based on the training images, and concentrations of the prototype distributions.

In further features, the ranking loss is a multi-similarity loss.

In further features, the segmentation module includes a plurality of transformer modules having the transformer architecture.

In further features, the method further includes, by the pose module: determining segmentation heatmaps based on the image; determining a global descriptor based on the segmentation heatmaps; selecting k images from memory based on similarities between the global descriptor and global descriptors of the k images, respectively; determining an initial pose based on the k most similar images; and determining the 6 DoF pose of the camera that captured the image based on the initial pose.

In further features, the similarities are cosine similarities.

In further features, the method further includes, by the pose module, determining the prototype distributions based on centers of the input of the ones of the training images.

In a feature, a pose determination method includes: determining segmentation heatmaps based on an image received from a camera; selecting k images from memory based on similarities between a global descriptor for the image and global descriptors of the k images, respectively, the map being stored in memory and including labeled three dimensional 3D points; determining an initial pose based on the k most similar images; and determining a 6 DoF pose of the camera that captured the image based on the initial pose and using the map.

In further features, the method further includes generating the global descriptor based on the image.

In further features, the method further includes generating the global descriptor using a pooling operator on the segmentation heatmaps.

In further features, determining the 6 DoF pose includes determining the 6 DoF pose further based on the segmentation heatmaps.

In further features, the labels of the three dimensional 3D points of the map correspond to segmentation classes.

In further features, the segmentation classes are semantic classes derived in a self-supervised manner using pixel correspondences.

In further features, the memory includes labeled three dimensional (3D) points includes for a set of reference images their corresponding camera pose and global descriptors but not their corresponding reference images.

In further features, each of the 3D points is associated to one of a predefined set of class labels.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a functional block diagram of an example implementation of a navigating robot;

FIGS. 2A, 2B, and 3 are functional block diagrams of example pose determination systems;

FIG. 4 is a functional block diagram of an example training system;

FIG. 5 includes example pairs of images with 2D-2D correspondences between the images of each pair from the training dataset;

FIG. 6 includes an example illustration of portions of the location and pose module of FIGS. 2A and 2B;

FIG. 7 illustrates example consistency losses;

FIG. 8 includes an algorithm for training the location and pose module used by the training module;

FIG. 9 is a flowchart depicting an example method of determining a refined pose and controlling movement of a robot.; and

FIG. 10 includes a functional block diagram including a visual localization system.

In the drawings, reference numbers may be reused to identify similar and/or identical elements.

### DETAILED DESCRIPTION

Visual navigation of mobile robots combines the domains of vision and control. The vision aspect involves image retrieval. Navigation can be described as finding a suitable and non-obstructed path between a starting location and a destination location. A navigating robot includes a control module configured to move the navigating robot based on input from one or more sensors (e.g., cameras) using a trained model.

Visual localization involves estimating a camera pose including position and orientation from which a captured image was taken in a known scene. Visual localization is used in multiple fields, such as self-driving vehicles, autonomous robots, mixed reality applications, and other fields.

Visual localization may use a three dimensional (3D) scene representation of the target area (the scene), which can be a 3D point cloud map, e.g., from Structure-from-Motion (SfM), or a learned 3D representation. The representation may be derived from reference images with known camera poses. The representation may be stored remotely or locally depending on the application, which implicate memory consumption and privacy preservation.

Regarding privacy preservation, it may be possible to reconstruct images from maps that contain local image features, which may be used for scene representation. This may decrease privacy regarding features in the image(s).

To increase privacy and decrease memory usage relative to feature-based approaches, the present application involves robust image segmentation where a global image representation for image retrieval along with a dense local representations suitable for building a compact 3D map—an order of magnitude smaller compared to feature-based approaches—and for accurate pose refinement. Using such representations for visual localization leads to robustness, increased privacy, and reduced memory consumption.

The visual localization pipeline may represent the scene via a 3D model. First, image retrieval based on a compact image representation is used to coarsely localize a query image. Given such an initial pose estimate, the camera pose is refined by aligning the query image to the 3D map. A more abstract representation in the form of a robust dense segmentation based on a set of clusters learned in a self-supervised manner is used.

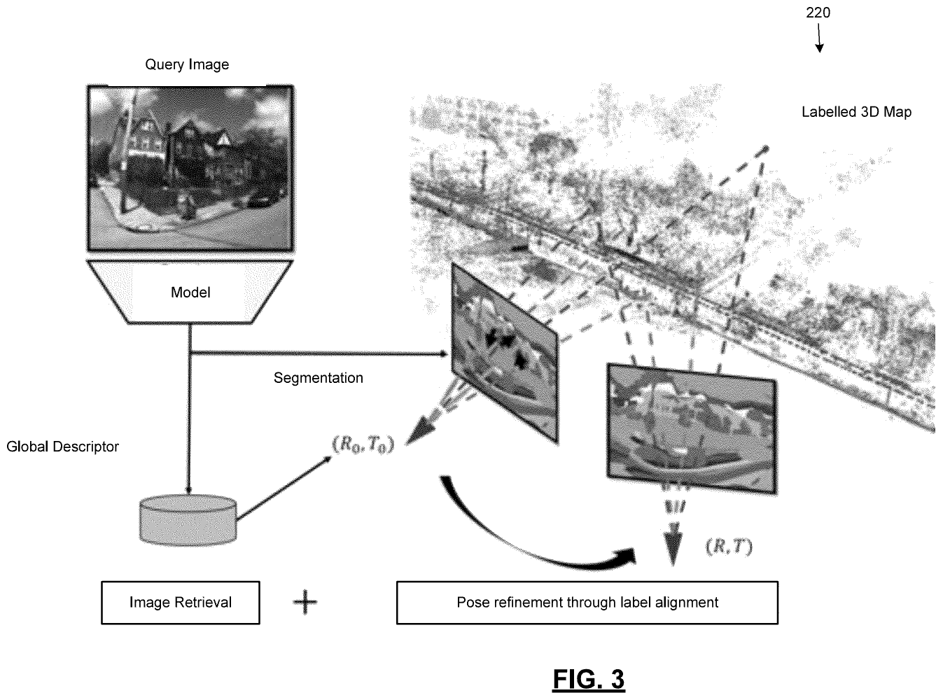

As illustrated in FIG. 3 as discussed further below, both global descriptors for image retrieval and a dense image representation for pose refinement are derived from the segmentation. The pose refinement is performed by maximizing labeling consistency between the predictions in the query image and a set of labeled 3D points in the scene. This has multiple advantages. First, the features described herein provide increased robustness to seasonal or appearance changes in the scene/environment as it depends less on low-level details and more on higher level representations learnt explicitly to be invariant to such variations. Second, it results in low storage requirements, as instead of storing high-dimensional feature descriptors, for each 3D point only stored may be its label. Third, the features described herein allows privacy-preserving visual localization as there is created a non-injective mapping from multiple images that show similar objects or object parts with different appearances to similar local/region labels.

To summarize, robust fine-grained image segmentations are learnt in a self-supervised manner by leveraging discriminative clustering and consistency regularization terms. A model, trained for localization, learns jointly global image representation to retrieve images for pose initialization and dense local representations for building a compact labeled 3D map—an order of magnitude smaller compared to feature-based approaches—and to perform privacy-preserving pose refinement.

There is a connection between segmentation-based representations and privacy-preserving localization, opening up viable alternatives to keypoint-based visual localization methods within the accuracy-privacy-memory trade-off. The proposed visual localization can be used in indoor and outdoor environments. The pose refinement includes estimating the accurate camera pose from its approximate pose by image alignment. Instead of using multi-scale deep features, the present application involves aligning predicted fine-grained segmentation and the corresponding 3D map by minimizing a reprojection error as a function of labeling inconsistency. The refinement may be performed based on a hierarchy of fine-grained segmentations jointly learned with global image representations where from coarser to finer segmentation maps are used leverage information from different levels of granularity. The present application directly optimizes/refines the 6DoF pose.

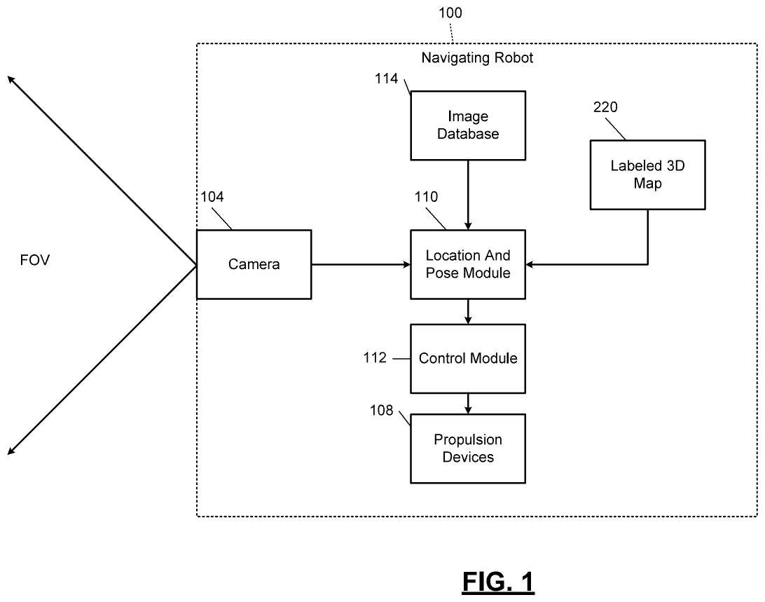

FIG. 1 is a functional block diagram of an example implementation of a navigating robot 100. The navigating robot 100 is a mobile vehicle. The navigating robot 100 includes a camera 104 that captures images within a predetermined field of view (FOV) in front of the navigating robot 100. The operating environment of the navigating robot 100 may be an indoor space or an outdoor space. In various implementations, the navigating robot 100 may include multiple cameras and/or one or more other types of sensing devices (e.g., LIDAR, radar, etc.).

The camera 104 may be, for example, a grayscale camera, a red, green, blue (RGB) camera, or another suitable type of camera. In various implementations, the camera 104 may also capture depth (D) information, such as in the example of a grayscale-D camera or a RGB-D camera. The camera 104 may be fixed to the navigating robot 100 such that the orientation and FOV of the camera 104 relative to the navigating robot 100 remains constant.

The navigating robot 100 includes one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly.

The navigating robot 100 includes a location and pose module 110 (or more simply a pose module) configured to determine a present location/position (e.g., three dimensional (3D) position) of the navigating robot 100 and a present pose (e.g., 3D orientation) of the navigating robot 100 based on input from the camera 104. A three 3D position of the navigating robot 100 and a 3D orientation of the navigating robot 100 may together be said to be a 6 dimension of freedom (6DoF) pose of the navigating robot 100. The 6 DoF pose may be a relative pose or an absolute pose of the navigating robot 100. A relative pose may refer to a pose of the navigating robot 100 relative to one or more objects in the environment around the navigating robot 100. An absolute pose may refer to a pose of the navigating robot 100 within a global coordinate system. The location and pose module 110 determines the pose as described further below.

The camera 104 may update at a predetermined frequency, such as 60 hertz (Hz), 120 Hz, or another suitable frequency. The location and pose module 110 may generate a location and/or the pose each time the input from the camera 104 is updated using a labeled three dimensional (3D) map 220.

A control module 112 is configured to control the propulsion devices 108 to navigate, such as from a starting location to a goal location, based on the location and the pose. For example, based on the location and the pose, the control module 112 may determine an action to be taken by the navigating robot 100. For example, the control module 112 may actuate the propulsion devices 108 to move the navigating robot 100 forward by a predetermined distance under some circumstances. The control module 112 may actuate the propulsion devices 108 to move the navigating robot 100 backward by a predetermined distance under some circumstances. The control module 112 may actuate the propulsion devices 108 to turn the navigating robot 100 to the right by the predetermined angle under some circumstances. The control module 112 may actuate the propulsion devices 108 to turn the navigating robot 100 to the left by the predetermined angle under some circumstances. The control module 112 may not actuate the propulsion devices 108 to not move the navigating robot 100 under some circumstances. The control module 112 may actuate the propulsion devices 108 to move the navigating robot 100 upward under some circumstances. The control module 112 may actuate the propulsion devices 108 to move the navigating robot 100 downward under some circumstances. The control module 112 may actuate the propulsion devices 108 to avoid the navigating robot 100 contacting any objects.

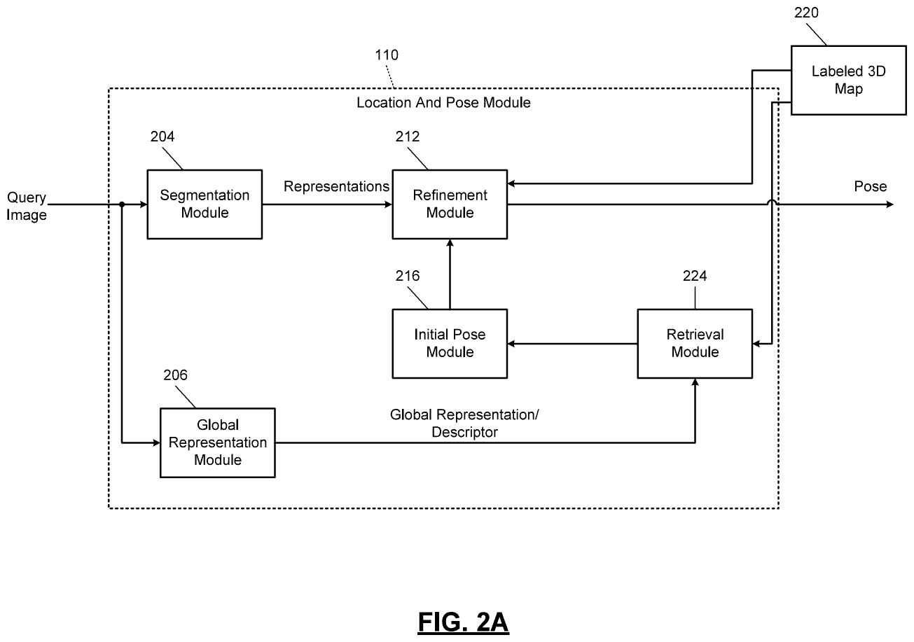

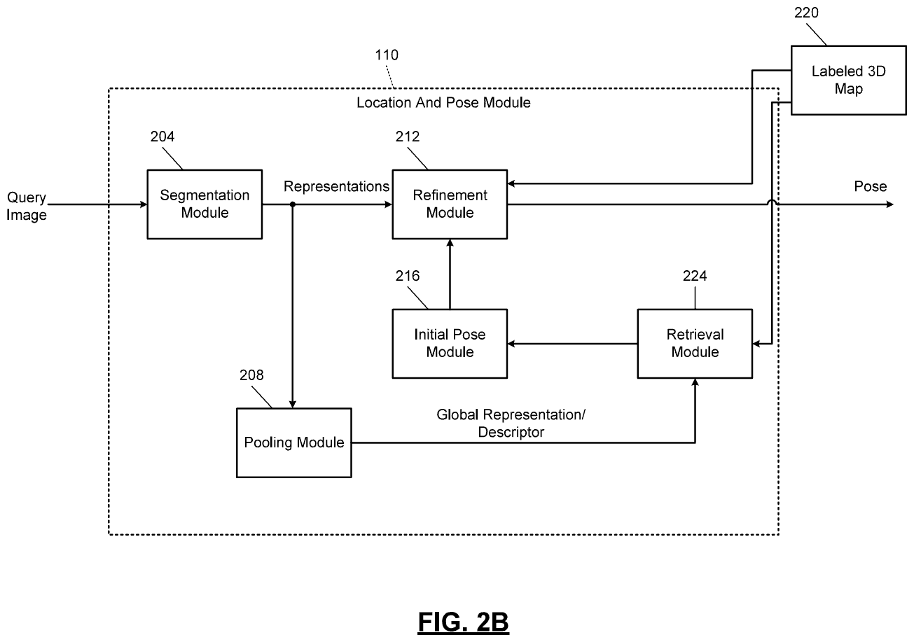

FIGS. 2A, 2B, and 3 are functional block diagrams of example pose determination systems. The example of FIG. 2A includes independent determination of a global representation based on a query image. The example of FIG. 2B includes joint determination of a global representation and a local representation. A goal is to jointly learn local and global image representations for visual localization. This involves a segmentation module 204 learning robust fine-grained segmentation in a weakly-supervised manner. For the weak supervision, an ensemble (dataset) of image pairs with a set of automatically extracted keypoint correspondences may be used.

The location and pose module 110 includes the segmentation module 204. The segmentation module 204 includes an encoder module and a decoder module as backbone such that the output of each layer is the input of the next layer. The resolutions of the output decoded feature maps Fₗ∈ [symbol] ^{D×H}^{ₗ}^{×W}^{ₗ} may progressively increase.

Each feature map Fₗ may be further processed by a classification module (head) of the segmentation module 204 to generate segmentation heatmaps Pₗ^{k}∈ [symbol] ^{H}^{ₗ}^{×W}^{ₗ}—with per pixel class likelihoods corresponding to the k-th cluster. In other words, at each hierarchy level l, the segmentation module 204 generates K segmentation heatmaps for the K classes corresponding to the K clusters, respectively. Examples of classes (and class labels) include ball, cat, horse, dog, car, etc. Each segmentation heatmap k includes for each pixel the likelihood that it belongs to the class k. A tensor may be generated by the segmentation module 204 by concatenating the K segmentation heatmaps at level l and may be denoted by Pₗ∈R^{K×H}^{ₗ}^{×W}^{ₗ} and may be an (e.g., abstract) representation of the query image.

As the decoder module outputs higher resolution feature (segmentation heat) maps, the encoded information becomes finer. Four or another suitable number of complementary distinct metric spaces and classification spaces may therefore be used (l∈1 . . . 4).

In the example of FIG. 2A, the location and pose module 110 includes a global representation module 206 that determines a global representation/descriptor based on the query image. In the example of FIG. 2B, a pooling module 208 pools the output representations of the segmentation module 204 to produce the global representation/descriptor.

A refinement module 212 may determine a refined pose (R,T) based on the segmentation heat maps, such as hierarchically from coarser to finer, and data (e.g., representations) in the map 220. This may leverage visual information captioned at different level of granularity. For pose approximation, only the finer segmentation may be used to compute a global representation. In the following, the level notation I will not be used for readability as the described functions are applied on each level without distinction.

The encoder module is pretrained and provides initial dense representations that are grouped into K clusters where K is controlling the granularity of information captured within in each cluster. This granularity is different than the spatial granularity level I, which corresponds to information captured at different layer resolution. To learn segmentation classes in a self-supervised manner, a Deep Discriminative Clustering (DDC) framework may be used as it may focus on learning the boundaries between clusters rather than explicitly modelling data distribution casting the clustering task as a classification problem. A training module (discussed further below) may use an auxiliary target to supervise the training by minimizing, for example, the Kullback-Leibler (KL) divergence between the predicted distributions P and target distributions Q.

To avoid degenerated solutions, a regularization term could be used by the training module to minimize KL(d^{q}∥d^{u}) between the empirical label distribution d_{q} which may be defined as the soft frequency of cluster assignments in the target distribution and the uniform distribution dᵤ to enforce a balanced cluster assignments. In the present application, however, the training module instead relies on the data itself to directly estimate an empirical label distribution dₚ. In addition, the training module may train the segmentation module 204 based on an entropy term H(Q) that encourages peaked target distributions. The clustering objective minimized by the training module may be described as follows:

$${ℒ}_{D C} = K L ( Q ‖ P ) + K L ( {d}^{q} ‖ {d}^{p} ) + H ( Q ) \qquad ( 1 )$$

where dₖ^{q}=Σᵢ^{HWB}qᵢₖ and B is the batch size. As this objective depends both on the target distributions Q and network parameters, it may be minimized by alternating the following two sub-steps (1. and 2. below) in every batch:
1. Update target distribution by the training module: With network parameters fixed, the following closed-form solution minimizes the cost function Eq. (1) in the batch of size B, such as using the equation:

$${q}_{{i}_{{b}^{k}}} = \frac{{d}_{k}^{p} {p}_{{i}_{b} k}^{2} / {( {\sum }_{{b}^{′} = 1}^{B} {\sum }_{{i}_{b}^{′} = 1}^{HW} {p}_{{i}_{b}^{′} k}^{2} )}^{\frac{1}{2}}}{{\sum }_{k = 1}^{K} {d}_{k}^{p} {p}_{{i}_{b} k}^{2} / ( {\sum }_{{b}^{′} = 1}^{B} {\sum }_{{i}_{{b}^{′}} = 1}^{HW} {p}_{{i}_{b}^{′} k}^{2} )} \qquad ( 2 )$$

2. The training module performs supervised learning/training of the segmentation module 204. With target distributions fixed, the training module may update one or more parameters of the segmentation module 204 based on minimizing the following per-pixel cross-entropy loss:

$${ℒ}_{C E} = - \frac{1}{H W B} {\sum }_{b = 1}^{B} {\sum }_{{i}_{b} = 1}^{H W} {\sum }_{k = 1}^{K} {q}_{{i}_{b} k} log ( σ ( {p}_{{i}_{b} k} ) ) \qquad ( 3 )$$

The segmentation module 204 may be self-supervised by auxiliary target distributions Q where qᵢₖ are computed from the initial class predictions pᵢₖ. However, these predictions may not be reliable at the beginning of the training process. During the first epoch, instead of using equation (2) to update Q, the training module may use initial prototypes (cluster centers) cₖ and compute soft assignments with respect to the associated cluster for each pixel xᵢ with a distribution, such as the Student's t-distribution, such as described by the equation:

$${q}_{ik} = \frac{{( 1 + {‖ {F}_{i} - {c}_{k} ‖}_{2}^{2} / α )}^{- \frac{α + 1}{2}}}{{\sum }_{j = 1}^{K} {( 1 + {‖ {F}_{i} - {c}_{j} ‖}_{2}^{2} / α )}^{- \frac{α + 1}{2}}} \qquad ( 4 )$$

using the corresponding feature vectors Fᵢ, and α=1. Using equation (4) in the first epoch may not only act as an initialization but also distils underlying prior knowledge helping the learning process to be more efficient.

Aiming to define dense representation robust to photometric changes while being equivariant to viewpoint changes and to avoid overfitting, the training module may train the segmentation module 204 based on (e.g., minimizing) the following three consistency regularization losses [symbol] _{CC}, [symbol] _{PC}, and [symbol] _{PF}.

Let lₐ, l_{b} be an image pair with the corresponding l2-normalized feature maps F^{a}=f_{θ}(l^{a}) and F^{b}=f_{θ}(l^{b}) respectively. The set of automatically obtained two dimensional 2D keypoint correspondences may be defined by

$${\{ {x}_{ul}^{a} , {x}_{v i}^{b} \}}_{l = 1}^{L}$$

where xᵤₗ^{a} and xᵥᵢ^{b} are keypoint locations in the feature map Fa and respectively Fb.

First, a correspondence consistency loss will be described. This loss may enforce consistency between pairs of segmentations

$${ℒ}_{C C} = - \frac{1}{2 L} {\sum }_{l = 1}^{L} {1}_{{S}_{{v}_{l}}^{b}}^{T} log ( α ( {p}_{{u}_{1}}^{a} ) ) + {1}_{{S}_{{u}_{l}}^{a}}^{T} log ( α ( {p}_{{v}_{1}}^{b} ) )$$

where pᵤₗ^{a}=h_{μ}(Fᵤₗ^{a}) and pᵥₗ^{b}=h_{μ}(Fᵥₗ^{b}), [symbol] ₖ is the one-hot vector with all zero values except at positions k, sᵤₗ^{a}, and sᵥₗ^{b} are assigned cluster labels to the keypoints xᵤₗ^{a} and xᵥₗ^{b} based on their distance prototypes {cₖ}ₖ₌₁^{K} obtained as sᵤₗ^{a}=argmaxₖcₖ^{T}Fᵤₗ^{a} and sᵥₗ^{b}=argmaxₖcₖ^{T}Fᵥₗ^{b}. Using the assigned prototypes instead of the target distribution may allow for the distillation of prior knowledge through the training process through the prototypes. The pose module may determine the initial prototypes based on the cluster centers of the training images input.

Second, a prototypical cross contrastive loss will be described. To constrain the feature space to ensure separability between the implicitly defined classes and to improve intra-class compactness, the following prototypical cross contrastive loss may be used (e.g., minimized) to train the segmentation module 204 by the training module and described by the equation

$${ℒ}_{P C} = - \frac{1}{2 L} {\sum }_{l = 1}^{L} log ( \frac{1}{Z} exp ( \frac{{c}_{{S}_{{v}_{l}}^{b}}^{T} {F}_{{u}_{l}}^{a}}{{∅}_{{S}_{{v}_{l}}^{b}}} + \frac{{c}_{{S}_{{u}_{l}}^{a}}^{T} {F}_{{v}_{l}}^{b}}{{∅}_{{S}_{{u}_{l}}^{a}}} ) )$$

with Z=(Σₖexp(cₖ^{T}Fᵤ_{ₗ}^{a}/∅ₖ))(Σₖexp(cₖ^{T}Fᵥ_{ₗ}^{b}/∅ₖ)), ϕₖ being the concentration of the prototype cₖ which may be defined as the average feature distance to the prototype within the cluster k and it may act as a scaling factor preventing cluster collapse. This loss incorporates in the feature space a structure conveyed by the prototypes.

Third, a feature consistency loss will be described, which may be used (e.g., minimized) by the training module. The feature consistency loss may be used to exploit the relationships between keypoints in the feature space (matching keypoints have similar representations) and may be described by the equation below to enforce feature consistency

$${ℒ}_{F C} = - \frac{1}{L} {\sum }_{l = 1}^{L} log \frac{exp ( {F}_{{u}_{l}}^{{a}^{T}} {F}_{{v}_{l}}^{b} / τ )}{{\sum }_{j = 1}^{L} exp ( {F}_{{u}_{l}}^{{a}^{T}} {F}_{j}^{b} / τ )} \qquad ( 5 )$$

The anchor/positive pairs may be provided by the pixel to pixel correspondences, while negative pairs may be obtained by sampling amongst the other keypoints in the set {xᵥⱼ^{b}, j≠l}. This loss may force the features of corresponding keypoints to be similar, hence facilitating the subsequent clustering.

To fully leverage these segmentation based representations, a pooling module 208 may determine a global image representation by applying a pooling operator on the segmentation heatmaps instead of the feature maps. The pooling operator may be, for example, the Generalized Pooling Operator (GPO) which may generalize over different pooling strategies to learn a most appropriate pooling strategy to describe the global content.

Given a heatmap's channel P^{k}∈ [symbol] ^{H×W}, the global representation may be defined as a weighted sum over sorted features:

$${v}^{k} = {\sum }_{0 = 1}^{H W} {θ}_{O} {ψ}_{O}^{d} where {\sum }_{0 = 1}^{H W} {θ}_{O} = 1 \qquad ( 6 )$$

where v^{k} is the k-th element of the output feature vector, ψₒ^{k} is the o-th element from the ordered descending lists of the values in the in the heatmap's channel, P^{k} and the weights θₒ are shared between the channels. The higher (or highest) resolution segmentation heatmap from the last level of the decoder module may be used as the input to the pooling module 208 to determine the global descriptor.

To increase the representational power, the segmentation module 204 may divide the query image into M overlapping sliding sub-windows and apply pooling within each sub-window. The corresponding features may be concatenated by the segmentation module yielding a global representation of dimension MK. In various implementations, the pooling module 206 may apply principle component analysis (PCA) and/or whitening, such as to reduce the dimension to 4096.

A goal of the training by the training module may be to minimize the multi-similarity loss which aims at exploiting self-similarity, negative, and positive relative similarities between these segmentation-based global representations. Given an anchor image Iⱼ^{a} the corresponding positive and respectively negative image sets can be denoted by [symbol] ₙ⁺={Iⱼ⁺} and [symbol] ₙ⁻={Iⱼ⁻} and the corresponding similarities determined between the pooled global representations by sⱼₙ⁺ and sⱼₙ⁻. The training module may determine the multi-similarity loss using the equation:

$${ℒ}_{M S} = - \frac{1}{N} {\sum }_{n = 1}^{N} {\sum }_{ρ ε \{ + , - \}} \frac{1}{{α}^{ρ}} log ( 1 + {\sum }_{{I}_{j}^{ρ} ϵ {N}_{n}^{ρ}} {e}^{{ρα}^{ρ} ( λ - {s}_{j n}^{ρ} )} )$$

where α₊, α₋ and λ are hyper-parameters. Image pairs included in the dataset may be used as an anchor/positive pair. The rest of positive/negative samples may be mined from {I_{n′}^{a}, I_{n′}^{b}}_{n′≠n} through a mining scheme (e.g., hard or semi-hard) based on features distances and image positions.

The location and pose module 110 determines the pose using a three dimensional (3D) representation of the environment, the 3D map 220, that includes for a set of reference images their corresponding camera pose and global descriptors (but not the images themselves) as well as a labelled 3D map that may be a sparse 3D model. Each 3D point is associated to one of a predefined set of class labels instead of a visual descriptor.

First, given a query image, the dense representations (segmentation heatmaps) and the global representation are determined as discussed above. A retrieval module 224 retrieves the k most relevant images from the map 220 based on global descriptor similarity (e.g., cosine similarity). k is a predetermined value and is an integer greater than or equal to 1. The initial pose module 216 determines an initial pose based on the retrieved images.

Second, the refinement module 212 refines the initial pose that was derived from the retrieved images. The refinement module 212 determines the refined pose based on the initial pose. The pose refinement process performed by the refinement module 212 may be described follows.

Let (R₀, T₀) be the initial pose obtained using the poses of the top-k retrieved similar images, and let X={(Xm, ym)} be the set of labeled 3D points visible in the top-k images, where Xm represents its 3D coordinates and ym the associated class label. To refine the initial pose, the refinement module 212 may use geometric optimization. To find the (refined) camera pose of the query image (R,T), the refinement module 212 does not use the reference images nor complex features. Instead, the refinement module 212 generate the refined pose by minimizing the label inconsistency between the reprojected 3D labels (yₘ) and the value (pₘ) in the predicted segmentation map of the query image. This may be defined by the equation

$$E ( R , T ) = {\sum }_{X} {w}_{m} ρ ( \vert {p}_{m} - {1}_{{y}_{m}} \vert ) \qquad ( 7 )$$

where 1k is the one-hot vector with all zero values except at position yₘ, pₘ is the segmentation class probability vector for xₘ=K(RXₘ+T), K being a query camera matrix, (R,T) the initial pose, and wₘ are learned weights, such as for outdoor environments or weights derived from edge detectors for indoor environments. In various implementations, the parenthetical in equation (7) may be replaced by a binary indicator of whether the same label is present or not.

(R,T) by (R₀, T₀) may be initialized and be iteratively refined by the refinement module 212 by minimizing equation (7), such as with the Levenberg-Marquart algorithm, where ρ being a Cauchy robust cost function

$$ρ ( x ) = \frac{{ψ}^{2}}{2} log ( 1 + \frac{{x}^{2}}{ψ} )$$

where ψ is a predetermined value, such as 0.1. In other words, the refinement module 212 may refine, execute equation (7), and stop once an increase in the result of equation (7) is obtained. The refinement module 212 may use the refined pose from the last instance before equation (7) increased. For each query image, the location and pose module 110 may perform this refinement with regard to the map 220 using coarser to finer segmentation-based representations.

As the query, the location and pose module 110 may either use the full segmentation heatmap, part of it or a single label representation. This is different than using a (e.g., dense) feature map. Using a one-hot query may provide a high level of privacy while increasing the amount of encoded information facilitates localization at the cost of lowering privacy.

For visual localization and pose determination, a computing device may transmit a query to a server. The server (e.g., including the location and pose module 110) performs visual localization using a stored 3D database (e.g., map 220) and returns the 6 DoF pose to the computing device. Privacy may be described in terms of the inability of an entity to recover details of the scene from either the query or the database. Determining the refined pose as described herein provides more privacy than other ways of determining pose, such as based on features. Memory use associated with the map 220 used herein may also be less than the memory used to determine pose based on features.

FIG. 3 is a functional block diagram illustrating the example of FIGS. 2A and 2B.

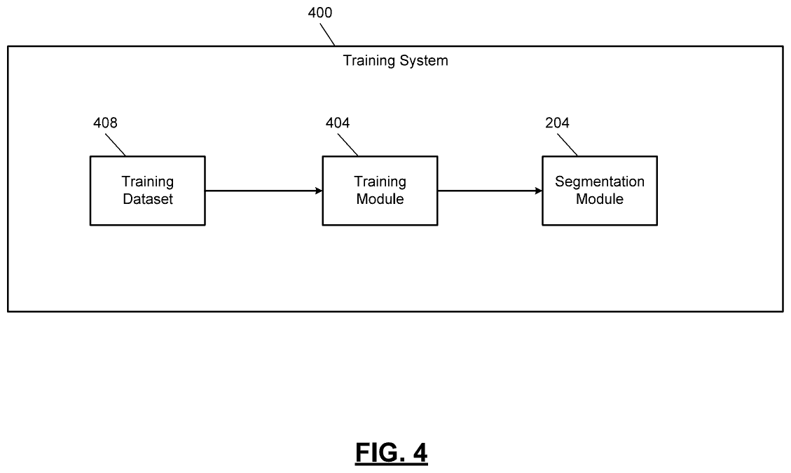

FIG. 4 is an example training system 400. A training module 404 trains the segmentation module 204 using a training dataset 408 as described herein. The segmentation module 204 may be trained offline, while the location and pose module 110 may perform an optimization process online during localization.

Regarding the training dataset 408 used by the training module 404 to train the location and pose module 110, the training dataset 408 may include a set of anchor/positive/negative images and pixel level information in the form of dense correspondences. For example, the training module 404 may, for example, determine repeatable and reliable detector and descriptor (R2D2) local descriptors in the images. The training module may merge image sets from different weather conditions to build a model (e.g., a structure from motion SfM model) by triangulating 2D matches using the camera poses then build a second model (e.g., a dense model) using a multi-view stereo pipeline. The training module 404 may split the resulting model (e.g., dense cloud points) into sub-point clouds, each of them being associated to a specific weather condition (based on the condition labels of the training images provided by the dataset). A 3D point may be associated with a sub-point cloud if it is observed by at least three images captured under that given weather condition. The SFM may be built with R2D2 features are used to generate the map 220 and the training data, but for the localization performed by the location and pose module 110 online, only the labels may be used and keypoint descriptors may be removed. During the training, the weight parameters wₘ may be trained by the training module 404.

Given a pair of sub-point clouds, 3D-3D correspondences may be established by the training module 404 by finding mutual nearest neighbors. Reprojecting these points into the images by the training module 404 yields a list of 2D-2D correspondences for all image pairs that are part of the sub-point clouds. The training module 404 may reject all 3D-3D correspondences whose reprojection error is greater than a threshold value, such as 5 pixels. The training module 404 may eliminate image pairs with less than a predetermined number of correspondences, such as 500 correspondences.

As another option, the training module 404 may build a model (e.g., a sparse SfM model) from scale invariant feature transform (SIFT) keypoints and not split the dense point cloud depending on capture condition as the scene may not evenly be covered by each capture condition. Thus for an image, the candidate image pair may be searched by the training module 404 among the whole training dataset 408. The global representations may be spatially pooled by the training module 404 from the dense segmentation which may be equivariant with respect to viewpoint change. As the global representations show some level of invariance to viewpoint change, the training image pairs may have limited viewpoint change and sufficient visual overlap. The bounding box containing all 2D points within the first image may be reprojected by the training module 404 in the second image and vice versa. Overlap ratios between the reprojected bounding boxes and images may be computed and used to select pairs with a sufficient correspondence coverage eliminating pairs below a predetermined value, such as 0.75 or another suitable value. The training module 404 may discard pairs with relative rotation differences greater than a predetermined value, such as 25 degrees or another suitable value.

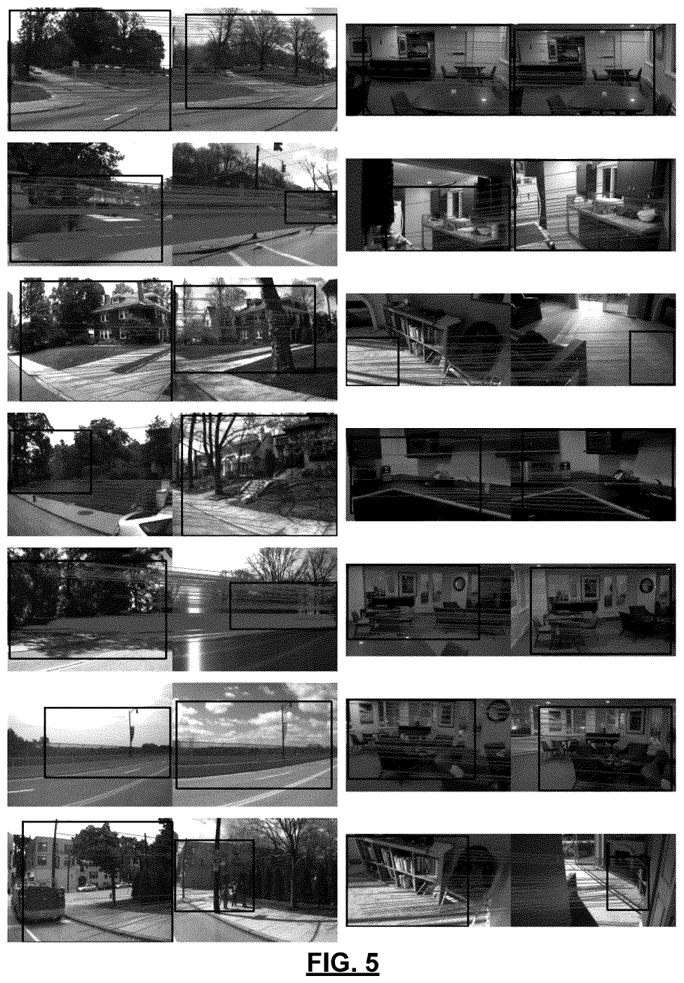

FIG. 5 includes example pairs of images with 2D-2D correspondences between the images of each pair from the training dataset 408.

An initial clustering may be performed by the segmentation module 204 to generate dense representations including initial prototype distributions (derived based on cluster centers), using the weights of a pretrained segmentation model that can be a semantic segmentation model. The derived prototypes play multiple roles. In the first epoch, the prototypes are used to determine the pseudo targets to train the classifiers, which may help to ensure a good initialization of the discriminative clustering phase. The prototypes also help to regularize the training process by incorporating some semantic structures in the feature space. To better ensure a good initialization, an available pre-trained semantic segmentation module 204 may be used to extract and cluster per pixel features considering a random subset of the training set (reference images). Using a pre-trained segmentation module may provide some meaningful features for the clustering.

For example only, the segmentation module 204 may include the DPT-hybrid model described in Rene Ranftl, et al., Vision Transformers for Dense Prediction, in ICCV, 2021, which is incorporated herein in its entirety. In the initialization step, reference images are processed and dense features from the encoder module are sampled and their associated predictions are collected. The dense features may be grouped according to their predictions (e.g., removing classes with low population). Within each remaining class, sub-clustering using K-means, meanshift, or another suitable type of clustering may be applied. The parameter k of K-means clustering or the Meanshift clustering's bandwidth such that the total number of prototypes equals the target granularity K of the segmentation. This initial clustering step may be applied independently on each level l of the hierarchical decoder module yielding four sets of initial prototypes, which may be refined during training to represent coarser to finer information.

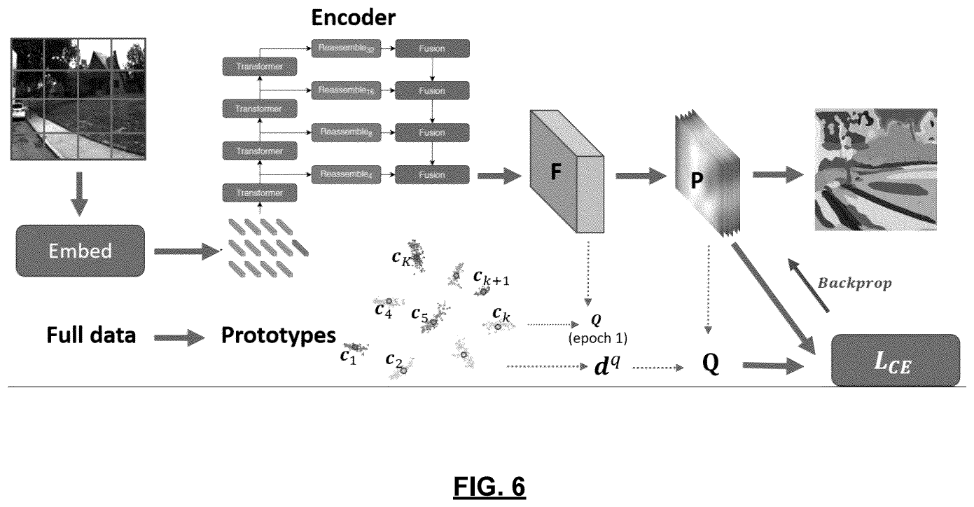

FIG. 6 includes an example illustration of portions of the segmentation module 204 of FIGS. 2A and 2B and illustrates the discriminative clustering process, which may be casted as a classification task. Pseudo targets Q are determined and used in determining per pixel cross-entropy loss [symbol] _{CE}. As discussed above, the segmentation module includes a hierarchical encoder/decoder module architecture, such as with vision transformer modules having the transformer architecture and convolutions. Transformer architecture as used herein is described in Ashish Vaswani, Noam Shazeer, Niki Parmar, Jakob Uszkoreit, Llion Jones, Aidan N Gomez, Łukasz Kaiser, and Illia Polosukhin, “Attention is all you need”, In I. Guyon, U. V. Luxburg, S. Bengio, H. Wallach, R. Fergus, S. Vishwanathan, and R. Garnett, editors, Advances in Neural Information Processing Systems 30, pages 5998-6008, Curran Associates, Inc., 2017, which is incorporated herein in its entirety. Additional information regarding the transformer architecture can be found in U.S. Pat. No. 10,452,978, which is incorporated herein in its entirety. The transformer architecture is one way to implement a self-attention mechanism, but the present application is also applicable to the use of other types of attention mechanisms.

After the initial clustering, the classification head of each decoder level of the pre-trained model may be replaced, such as with a randomly initialized multi layer perceptron (MLP) followed by batch normalization. The number of target semantic classes is set to K. K may be, for example, 100 or another suitable value. Coarser or finer segmentations may be achieved by varying K. The dimension of the feature map F is set to D, such as 256 or another suitable value.

The training module 404 may train the location and pose module 110 using Adam optimizer with an initial learning rate, such as 2e−3 and a predetermined weight decay, such as 1e−4.

In the example of FIG. 6, the prototypes/feature similarities may be used as targets during the first epoch. In the following epochs, the target distributions may act as pseudo-labels to guide the segmentation.

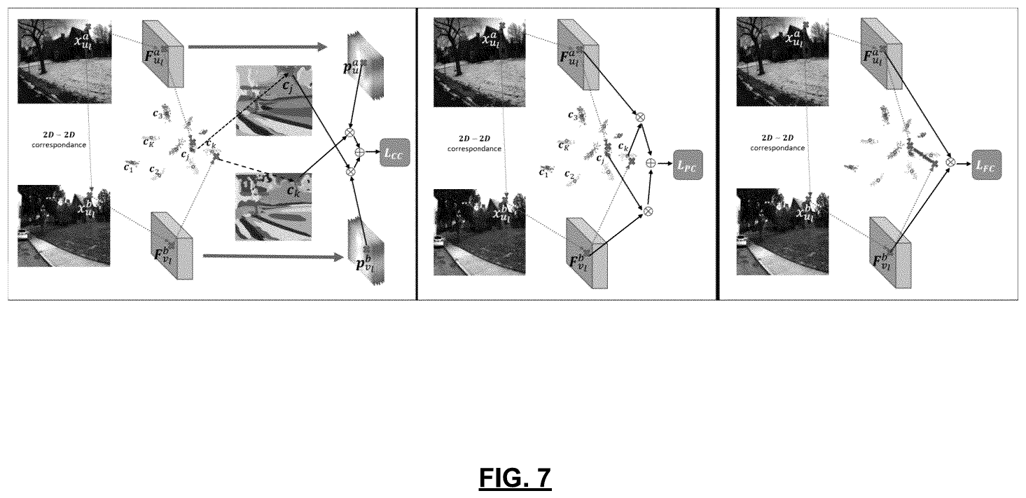

FIG. 7 illustrates the behavior of consistency losses [symbol] _{CC}, and [symbol] _{FC} and contrastive loss [symbol] _{PC} discussed above. Given a pixel to pixel correspondence and a set of prototypes, consistency may be enforced between the representations while class information may be infused from the prototypes. The left most diagram of FIG. 7 illustrates the consistency loss [symbol] _{FC} between the values in the segmentation heatmap of corresponding keypoints. The middle diagram of FIG. 7 illustrates the prototypical cross contrastive loss [symbol] _{PC}. The right most diagram of FIG. 7 illustrates the feature consistency loss [symbol] _{FC}.

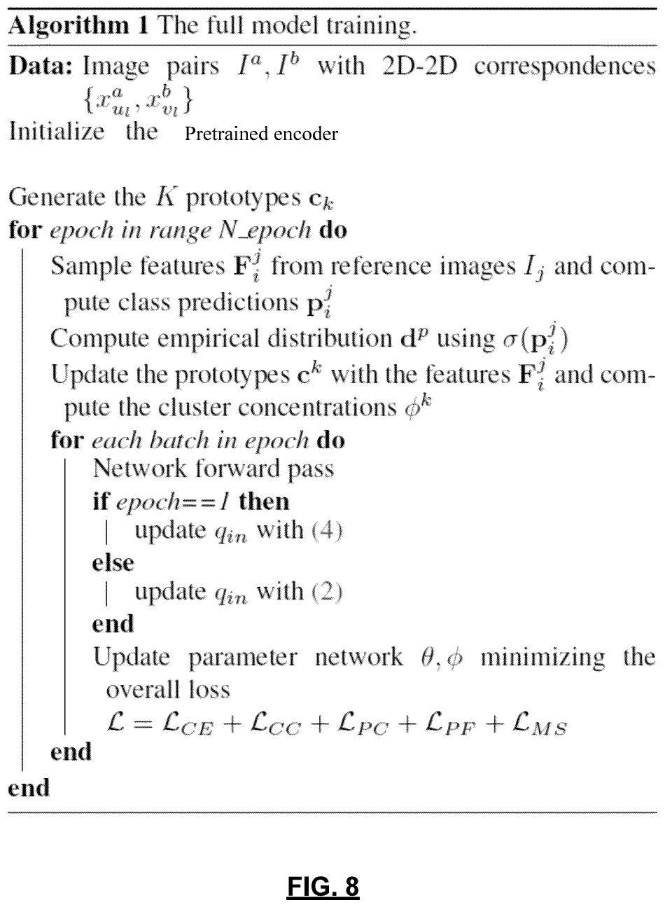

FIG. 8 includes an algorithm for training the segmentation module 204 used by the training module 404. First, the training module 404 initializes the pre-trained encoder module of segmentation module 204. Then the segmentation module 204 generates the initial K prototypes and learns the model to generate the dense and global representations based on the image pairs of the training dataset 408.

For each epoch of a predetermined number of epochs (a range), the segmentation module 204 samples features from the reference images and determines class predictions as discussed above. The segmentation module 204 determines an empirical distribution as discussed above and updates the prototypes based on the features and determines the cluster concentrations.

For each batch in an epoch, the training module 404 determines q using equation (4) above during the first epoch. During each epoch after the first epoch, the training module 404 determines q using equation (2) above. For each batch, the training module 404 determines the losses discussed above, determines a total (overall) loss as shown, and updates one or more parameters of the segmentation module 110 based on minimizing the total loss.

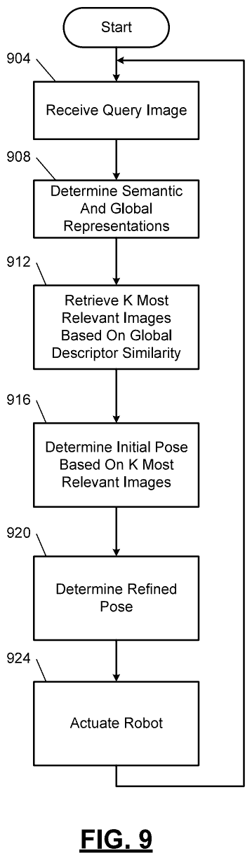

FIG. 9 is a flowchart depicting an example method of determining a refined pose and controlling movement of a robot. Control begins with 904 where the location and pose module 110 receives an image, such as an image from the camera 104. The location and pose module 110 is configured and trained to determine a refined pose of the camera that captured the image.

At 908, the segmentation module 204 determines the dense segmentation-based representations and the global descriptor for the query image as discussed above. At 912, the retrieval module 224 retrieves or identifies the k most relevant images based on similarities (e.g., cosine) between the global descriptor of the query image and the global descriptors of the images in the map 220.

At 916, initial pose module 216 determines the initial 6 DoF pose based on the k most relevant images retrieved from the map 220. At 920, the refinement module 212 determines the refined 6 DoF pose by refining the initial 6 DoF pose as discussed above. At 924, the control module 112 may control actuation of one or more of the propulsion devices or other actuators of the robot based on the refined 6 DoF pose.

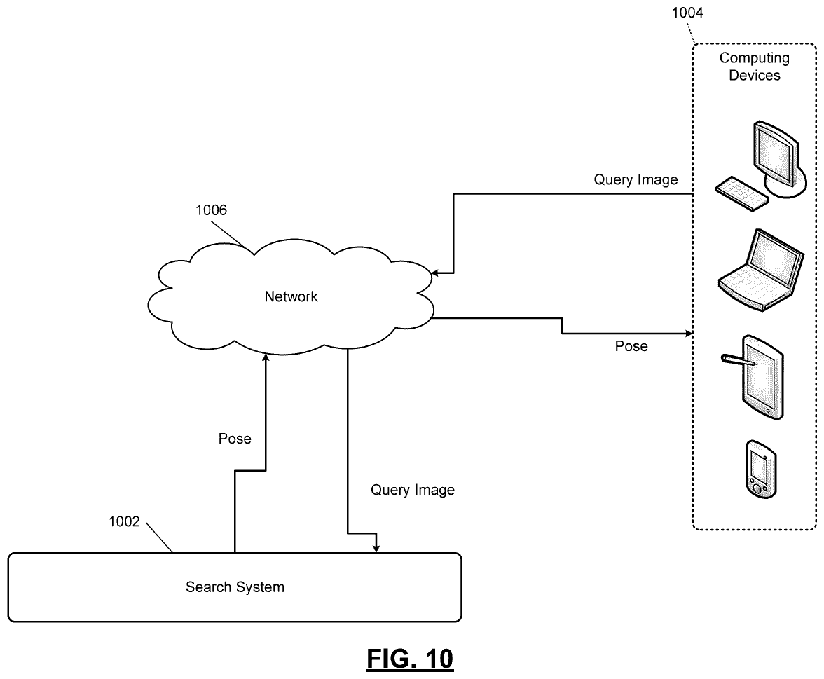

FIG. 10 includes a functional block diagram including a visual localization system. A search system 1002 (e.g., including the location and pose module 110) is configured to respond to queries. The search system 1002 is configured to receive queries from one or more computing device(s) 1004 via a network 1006. The queries may be, for example, images, such as images captured using a camera of the computing device and/or images captured in one or more other manners.

The search system 1002 determine a pose of the camera that captured the image as discussed above. The search system 1002 may also perform searches for images based on the queries, respectively, to identify one or more search results. The search system 1002 transmits the 6 DoF pose and/or results back to the computing devices 1004 that transmitted the queries, respectively. For example, the search system 1002 may receive a query including an image from a computing device. The search system 1002 may provide a matching image having a closest 6 DoF to the query image and other information about one or more objects in the images back to the computing device.

The computing devices 1004 output the results to users. For example, the computing devices 1004 may display the results to users on one or more displays of the computing devices and/or one or more displays connected to the computing devices. Additionally or alternatively, the computing devices 1004 may audibly output the results via one or more speakers. The computing devices 1004 may also output other information to the users. For example, the computing devices 1004 may output additional information related to the results, advertisements related to the results, and/or other information. The search system 1002 and the computing devices 1004 communicate via a network 1006.

A plurality of different types of computing devices 1004 are illustrated in FIG. 10. The computing devices 1004 include any type of computing devices that is configured to generate and transmit queries to the search system 1002 via the network 1006. Examples of the computing devices 1004 include, but are not limited to, smart (cellular) phones, tablet computers, laptop computers, and desktop computers, as illustrated in FIG. 10. The computing devices 1004 may also include other computing devices having other form factors, such as computing devices included in vehicles, gaming devices, televisions, consoles, or other appliances (e.g., networked refrigerators, networked thermostats, etc.).

The computing devices 1004 may use a variety of different operating systems. In an example where a computing device 1004 is a mobile device, the computing device 1004 may run an operating system including, but not limited to, Android, iOS developed by Apple Inc., or Windows Phone developed by Microsoft Corporation. In an example where a computing device 1004 is a laptop or desktop device, the computing device 1004 may run an operating system including, but not limited to, Microsoft Windows, Mac OS, or Linux. The computing devices 1004 may also access the search system 1002 while running operating systems other than those operating systems described above, whether presently available or developed in the future.

In some examples, a computing device 1004 may communicate with the search system 1002 using an application installed on the computing device 1004. In general, a computing device 1004 may communicate with the search system 1002 using any application that can transmit queries to the search system 1002 to be responded to (with results) by the search system 1002. In some examples, a computing device 1004 may run an application that is dedicated to interfacing with the search system 1002, such as an application dedicated to performing searching and providing search results. In some examples, a computing device 1004 may communicate with the search system 1002 using a more general application, such as a web-browser application. The application executed by a computing device 1004 to communicate with the search system 1002 may display a search field on a graphical user interface (GUI) in which the user may input queries.

Additional information may be provided with a query, such as text. A text query entered into a GUI on a computing device 1004 may include words, numbers, letters, punctuation marks, and/or symbols. In general, a query may be a request for information identification and retrieval from the search system 1002. For example, a query including text may be directed to providing information regarding a subject (e.g., a business, point of interest, product, etc.) of the text of the query.

A computing device 1004 may receive results from the search system 1002 that is responsive to the search query transmitted to the search system 1002. In various implementations, the computing device 1004 may receive and the search system 1002 may transmit multiple results that are responsive to the search query or multiple items (e.g., entities) identified in a query. In the example of the search system 1002 providing multiple results, the search system 1002 may determine a confidence value for each of the results and provide the confidence values along with the results to the computing device 1004. The computing device 1004 may display more than one of the multiple results (e.g., all results having a confidence value that is greater than a predetermined value), only the result with the highest confidence value, the results having the N highest confidence values (where N is an integer greater than one), etc.

The computing device 1004 may be running an application including a GUI that displays the result(s) received from the search system 1002. The respective confidence value(s) may also be displayed, or the results may be displayed in order (e.g., descending) based on the confidence values. For example, the application used to transmit the query to the search system 1002 may also present (e.g., display or speak) the received search results(s) to the user via the computing device 1004. As described above, the application that presents the received result(s) to the user may be dedicated to interfacing with the search system 1002 in some examples. In other examples, the application may be a more general application, such as a web-browser application.

The GUI of the application running on the computing device 1004 may display the search result(s) to the user in a variety of different ways, depending on what information is transmitted to the computing device 1004. In examples where the results include a list of results and associated confidence values, the search system 1002 may transmit the list of results and respective confidence values to the computing device 1004. In this example, the GUI may display the result(s) and the confidence value(s) to the user as a list of possible results.

In some examples, the search system 1002, or another computing system, may transmit additional information to the computing device 1004 such as, but not limited to, applications and/or other information associated with the results, the query, points of interest associated with the results, etc. This additional information may be stored in a data store and transmitted by the search system 1002 to the computing device 1004 in some examples. In examples where the computing device 1004 receives the additional information, the GUI may display the additional information along with the result(s). In some examples, the GUI may display the results as a list ordered from the top of the screen to the bottom of the screen by descending confidence value. In some examples, the results may be displayed under the search field in which the user entered the query.

In some examples, the computing devices 1004 may communicate with the search system 1002 via another computing system. The other computing system may include a computing system of a third party using the search functionality of the search system 1002. The other computing system may belong to a company or organization other than that which operates the search system 1002. Example parties which may leverage the functionality of the search system 1002 may include, but are not limited to, internet search providers and wireless communications service providers. The computing devices 1004 may send queries to the search system 1002 via the other computing system. The computing devices 1004 may also receive results from the search system 1002 via the other computing system. The other computing system may provide a user interface to the computing devices 1004 in some examples and/or modify the user experience provided on the computing devices 1004.

The computing devices 1004 and the search system 1002 may be in communication with one another via the network 1006. The network 1006 may include various types of networks, such as a wide area network (WAN) and/or the Internet. Although the network 1006 may represent a long range network (e.g., Internet or WAN), in some implementations, the network 1006 may include a shorter range network, such as a local area network (LAN). In one embodiment, the network 1006 uses standard communications technologies and/or protocols. Thus, the network 1006 can include links using technologies such as Ethernet, Wireless Fidelity (WiFi) (e.g., 802.11), worldwide interoperability for microwave access (WiMAX), 3G, 4G, 5G, Long Term Evolution (LTE), digital subscriber line (DSL), asynchronous transfer mode (ATM), InfiniBand, PCI Express Advanced Switching, etc. Similarly, the networking protocols used on the network 1006 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1006 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In other examples, the network 1006 can use custom and/or dedicated data communications technologies instead of, or in addition to, the ones described above.

As one example, a computing device may transmit an image to the search system 1002 including an object, such as a landmark, etc. The search system 1002 may determine one or more images having a 6 DoF pose closest to the 6 DoF pose of the query image and links (e.g., hyperlinks) to websites including information on the object in the query image. The search system 1002 may transmit the images and the links back to the computing device for consumption.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A training system, comprising:
a pose module configured to:
receive an image captured using a camera; and
determine a 6 degree of freedom (DoF) pose of the camera that captured the image; and
a training module configured to:
input training images to the pose module from a training dataset; and
train a segmentation module of the pose module by alternating between:
updating a target distribution with parameters of the segmentation module fixed based on minimizing a first loss determined based on a label distribution determined based on prototype distributions determined by the pose module based on input of ones of the training images;
updating the parameters of the segmentation module with the target distribution fixed based on minimizing a second loss determined based on a second loss that is different than the first loss; and
updating the parameters of the segmentation module based on a ranking loss using a global representation.

2. The training system of claim 1 wherein the second loss is a per pixel cross-entropy loss.

3. The training system of claim 1 wherein the training module is configured to train the segmentation module based on:
a first function based on feature vectors and prototype distributions during a first epoch of a predetermined number of epochs of the training; and
a second function during the remainder of the predetermined number of epochs after the first epoch.

4. The training system of claim 1 wherein the training module is configured to train the pose module further based on minimizing a consistency loss.

5. The training system of claim 4 wherein the training module is configured to determine the consistency loss based on labels assigned to keypoints in the training images based on their distance to prototype distributions.

6. The training system of claim 4 wherein the training module is configured to determine the consistency loss based on feature maps determined based on the training images.

7. The training system of claim 1 wherein the training module is configured to train the segmentation module further based on minimizing a contrastive loss.

8. The training system of claim 7 wherein the training module is configured to determine the contrastive loss based on based on prototype distributions determined based on ones of the training images, feature maps determined based on the training images, and concentrations of the prototype distributions.

9. The training system of claim 1 wherein the ranking loss is a multi-similarity loss.

10. The training system of claim 1 wherein the segmentation module includes a plurality of transformer modules having the transformer architecture.

11. The training system of claim 1 wherein the pose module is configured to:
determine segmentation heatmaps based on the image;
determine a global descriptor based on the segmentation heatmaps;
select k images from memory based on similarities between the global descriptor and global descriptors of the k images, respectively;
determine an initial pose based on the k most similar images; and
determine the 6 DoF pose of the camera that captured the image based on the initial pose.

12. The training system of claim 11 wherein the similarities are cosine similarities.

13. The training system of claim 1 wherein the pose module is configured to determine the prototype distributions based on centers of the input of the ones of the training images.

14. A pose determination system, comprising:
a segmentation module configured to determine segmentation heatmaps based on an image received from a camera;
a retrieval module configured to select k images from memory based on similarities between a global descriptor for the image and global descriptors of the k images, respectively,
the map being stored in memory and including labeled three dimensional 3D points;
an initial pose module configured to determine an initial pose based on the k most similar images; and
a refinement module configured to determine a 6 DoF pose of the camera that captured the image based on the initial pose and using the map.

15. The pose determination system of claim 14 further comprising a global representation module configured to generate the global descriptor based on the image.

16. The pose determination system of claim 14 further comprising a pooling module configured to generate the global descriptor using a pooling operator on the segmentation heatmaps.

17. The pose determination system of claim 14 wherein the refinement module is configured to determine the 6 DoF pose further based on the segmentation heatmaps.

18. The pose determination system of claim 14 wherein the labels of the three dimensional 3D points of the map correspond to segmentation classes.

19. The pose determination system of claim 18 wherein the segmentation classes are semantic classes derived in a self-supervised manner using pixel correspondences.

20. The pose determination system of claim 14 wherein the memory includes labeled three dimensional (3D) points includes for a set of reference images their corresponding camera pose and global descriptors but not their corresponding reference images.

21. The pose determination system of claim 20 wherein each of the 3D points is associated to one of a predefined set of class labels.

22. A training method, comprising:
receiving an image captured using a camera;
determining, by a pose module, a 6 degree of freedom (DoF) pose of the camera that captured the image;
input training images to the pose module from a training dataset; and
training a segmentation module of the pose module by alternating between:
updating a target distribution with parameters of the segmentation module fixed based on minimizing a first loss determined based on a label distribution determined based on prototype distributions determined by the pose module based on input of ones of the training images;
updating the parameters of the segmentation module with the target distribution fixed based on minimizing a second loss determined based on a second loss that is different than the first loss; and
updating the parameters of the segmentation module based on a ranking loss using a global representation.

23. The training method of claim 22 wherein the second loss is a per pixel cross-entropy loss.

24. The training method of claim 22 wherein the training includes training the segmentation module based on:
a first function based on feature vectors and prototype distributions during a first epoch of a predetermined number of epochs of the training; and
a second function during the remainder of the predetermined number of epochs after the first epoch.

25. The training method of claim 22 wherein the training includes training the pose module further based on minimizing a consistency loss.

26. The training method of claim 25 wherein the training includes determining the consistency loss based on labels assigned to keypoints in the training images based on their distance to prototype distributions.

27. The training method of claim 25 wherein the training includes determining the consistency loss based on feature maps determined based on the training images.

28. The training method of claim 22 wherein the training includes training the segmentation module further based on minimizing a contrastive loss.

29. The training method of claim 28 wherein the training incudes determining the contrastive loss based on based on prototype distributions determined based on ones of the training images, feature maps determined based on the training images, and concentrations of the prototype distributions.

30. The training method of claim 22 wherein the ranking loss is a multi-similarity loss.

31. The training method of claim 22 wherein the segmentation module includes a plurality of transformer modules having the transformer architecture.

32. The training method of claim 22 further comprising, by the pose module:
determining segmentation heatmaps based on the image;
determining a global descriptor based on the segmentation heatmaps;
selecting k images from memory based on similarities between the global descriptor and global descriptors of the k images, respectively;
determining an initial pose based on the k most similar images; and
determining the 6 DoF pose of the camera that captured the image based on the initial pose.

33. The training method of claim 32 wherein the similarities are cosine similarities.

34. The training method of claim 22 further comprising, by the pose module, determining the prototype distributions based on centers of the input of the ones of the training images.

35. A pose determination method, comprising:
determining segmentation heatmaps based on an image received from a camera;
selecting k images from memory based on similarities between a global descriptor for the image and global descriptors of the k images, respectively,
the map being stored in memory and including labeled three dimensional 3D points;
determining an initial pose based on the k most similar images; and
determining a 6 DoF pose of the camera that captured the image based on the initial pose and using the map.

36. The pose determination method of claim 35 further comprising generating the global descriptor based on the image.

37. The pose determination method of claim 35 further comprising generating the global descriptor using a pooling operator on the segmentation heatmaps.

38. The pose determination method of claim 35 wherein determining the 6 DoF pose includes determining the 6 DoF pose further based on the segmentation heatmaps.

39. The pose determination method of claim 35 wherein the labels of the three dimensional 3D points of the map correspond to segmentation classes.

40. The pose determination method of claim 39 wherein the segmentation classes are semantic classes derived in a self-supervised manner using pixel correspondences.

41. The pose determination method of claim 35 wherein the memory includes labeled three dimensional (3D) points includes for a set of reference images their corresponding camera pose and global descriptors but not their corresponding reference images.

42. The pose determination method of claim 41 wherein each of the 3D points is associated to one of a predefined set of class labels.
